(19) United States
(12) Patent Application Publication
(10) Pub. No.: US 2022/0027878 A1
(43) Pub. Date: Jan. 27, 2022

(54) BIOMETRIC TRAVEL SYSTEM

(71) Applicant: Bank of America Corporation, Charlotte, NC (US)

(72) Inventors: Albena N. Fairchild, Indian Trail, NC (US); Brandon Sloane, Charlotte, NC (US); Vijaya L. Vemireddy, Plano, TX (US)

(21) Appl. No.: 16/937,768

(22) Filed: Jul. 24, 2020

(51) Int. Cl. G06Q 20/18; G06Q 50/30; G06Q 20/20; G06Q 20/40; G06Q 30/00; G06Q 50/26; G06Q 50/14; G06F 21/32; H04N 1/44; H04N 1/00

(52) U.S. Cl. CPC G06Q 20/18; G06Q 50/30; G06Q 20/206; G06Q 20/40145; G06Q 30/0185; H04N 1/00514; G06Q 20/4012; G06Q 50/14; G06F 21/32; H04N 1/442; G06Q 50/265

(57) ABSTRACT

A method for identifying a traveler at a kiosk for international travel is provided. The method may include reading, at a biometric reader included in the kiosk, a biometric identifier of a traveler. The method may include generating a digital rendering of the biometric identifier. The method may include receiving, at an electronic input receiver, a PIN number from the traveler. The method may include transmitting the digital rendering and the PIN to a central server. The method may include validating the digital rendering and the PIN at the central server. The method may include retrieving information associated with the traveler at the central server. The information may include look and feel preferences. The method may include transmitting the retrieved information, including the look and feel preferences, to the kiosk. The method may include displaying the look and feel preferences on a display included in the kiosk.

### FIELD OF TECHNOLOGY

Aspects of the disclosure relate to systems for enhancing ease of travel.

### BACKGROUND OF THE DISCLOSURE

Increasing ease of travel while maintaining high levels of travel security has become more important in recent years. Typically, travel information, such as an itinerary, is stored on a traveler's mobile device. As such, in the event the device is lost or stolen, it may be difficult for the traveler to retrieve travel information en route.

Also, a traveler may have difficulty adapting to differences in language, culture and topography. As such, basic necessities, such as banking and identification documentation retrieval may be difficult to obtain. Specifically, lost or stolen documentation may be difficult to duplicate en route.

Therefore, an international kiosk may be desirable.

It would be desirable for the international kiosk to replicate the look and feel of an automated teller machine associated with the traveler's primary residence.

It would be yet further desirable for the look and feel replication to ease the traveler's geographic transition.

### SUMMARY OF THE DISCLOSURE

An international kiosk is provided. The international kiosk may preferably utilize a biometric identifier in order to authenticate a traveler. As such, the traveler may be unable to misplace or forget the authentication data. The international kiosk may be operable to dispense currency and documentation to a traveler in response to receipt of the traveler's biometric identifier.

A method for biometric travel is also provided. The method may include pre-registering a traveler's biometric identifier. The biometric identifier may be a fingerprint, a face scan, an iris scan or any other suitable biometric identifier. The biometric identifier may be registered at a central server. The biometric identifier may be registered prior to travel.

Pre-registering a biometric identifier may include receiving the biometric identifier from an individual. The biometric identifier may be received at a first international traveler's kiosk. The first international traveler's kiosk may generate a digital rendition of the biometric identifier. It should be appreciated that the first international traveler's kiosk may be located at or near a primary residence of the traveler. The first international traveler's kiosk may transmit the digital rendition of the biometric identifier and personally identifiable information about the traveler to a central server.

The central server may store the digital rendition of the biometric identifier within a storage location. The central server may also store the received personally identifiable information about the traveler together with the biometric identifier. Therefore, the biometric identifier may be linked to personally identifiable information associated with the traveler.

The central server may be linked to multiple international traveler's kiosks around the globe. The method may include receiving a biometric identifier from the traveler at a second international traveler's kiosk. The second international traveler's kiosk may generate a digital rendition of the biometric identifier. The second international traveler's kiosk may transmit the generated digital rendition of the biometric identifier to the central server.

The central server may receive the digital rendition of the biometric identifier. The central server may retrieve the personally identifiable information associated with the traveler. The central server may transmit the personally identifiable information to the second international traveler's kiosk.

The personally identifiable information may include bank account information, passport information, travel documentation, driver's license documentation, foreign identification documentation and/or any other suitable information. The second international traveler's kiosk may be operable to print such documentation for an authenticated traveler. The second international traveler's kiosk may also be operable to dispense currency to the traveler. The second international traveler's kiosk may communicate with the traveler's bank account via the central server. As such, the second international traveler's kiosk may operate as an international automated teller machine.

The personally identifiable information may also include look and feel characteristics of an automated teller machine previously associated with the traveler. Such an automated teller machine may be an automated teller machine located near a primary residence of the traveler. Such look and feel characteristics may include language characteristics. Such look and feel characteristics may also include a plurality of selectable options. Such look and feel characteristics may also include font size, display colors, audio sound and instructional videos. Such look and feel characteristics may also include, for each of the plurality of selectable options, a location with respect to the display. Such look and feel characteristics may also include one or more colors to be displayed on the display.

In some embodiments, a personal identification number (“PIN”) may be received together with the biometric identifier. The PIN may be received at an electronic input receiver included in the kiosk for international travel. In order to retrieve the personally identifiable information, the biometric identifier and the PIN may be received.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure;

FIG. 4 shows still another illustrative diagram in accordance with principles of the disclosure;

FIG. 5 shows yet another illustrative diagram in accordance with principles of the disclosure; and

FIG. 6 shows still another illustrative diagram in accordance with principles of the disclosure;

FIG. 7 shows yet another illustrative diagram in accordance with principles of the disclosure; and

FIG. 8 shows still yet another illustrative diagram in accordance with principles of the disclosure.

### DETAILED DESCRIPTION OF THE DISCLOSURE

Apparatus and methods for a kiosk for international travel may be provided. The kiosk may include a biometric reader. The biometric reader may be operable to read a traveler's biometric identifier(s).

The kiosk may also include a processor. The processor may be operable to generate a digital rendering of the biometric identifier.

The kiosk may also include a transmitter. The transmitter may be operable to transmit the digital rendering of the biometric identifier to a central server.

The kiosk may also include a receiver. The receiver may be operable to receive personally identifiable information associated with the traveler. The personally identifiable information may be received from the central server.

The personally identifiable information may include bank account information, passport information, travel documentation, driver's license documentation, foreign identification documentation and any other suitable information. The kiosk may be operable to print such documentation for an authenticated traveler. The kiosk may also be operable to dispense currency to the traveler. The kiosk may communicate with the traveler's bank account via the central server. As such, the kiosk may operate as an international automated teller machine.

The personally identifiable information may also include look and feel preferences associated with an automated teller machine associated with the traveler. Such an automated teller machine may be an automated teller machine located near a primary residence of the traveler. Such look and feel preferences may include language preferences. Such look and feel preferences may also include a plurality of selectable options. Such look and feel preferences may also include, for each of the plurality of selectable options, a location on the display. The location on the display may be in respect to a size of the display. Such look and feel preferences may also include one or more colors to be displayed on a display of the kiosk.

The kiosk for international travel may also include a display. The display may be operable to display the plurality of look and feel preferences of the automated teller machine associated with the traveler.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

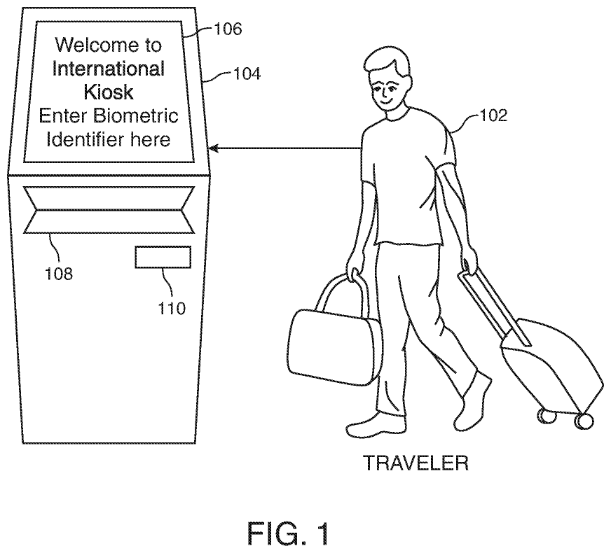

FIG. 1 shows an illustrative diagram. The illustrative diagram shows traveler 102 arriving at international kiosk 104. International kiosk 104 may be located in various locations around the globe. International kiosk 104 may include display 106. Display 106 may display various screens to traveler 102. The display screens may be stored in memory included in kiosk 104. The display screens may also be received from a server.

International kiosk 104 may also include incoming/outgoing slots 108 and 110. Incoming/outgoing slots 108 and 110 may be operable to receive various types of documentation from traveler 102. The documentation may include traveling documentation, passport documentation, currency, license documentation and identification documentation.

Incoming/outgoing slots 108 and 110 may also be operable to receive various types of documentation from traveler 102. The documentation may include traveling documentation, passport documentation, currency, license documentation and identification documentation.

International kiosk 104 may be used by traveler 102 to perform the various functions described above. International kiosk 104 may also be used by traveler 102 to pre-register a biometric identifier prior to traveling.

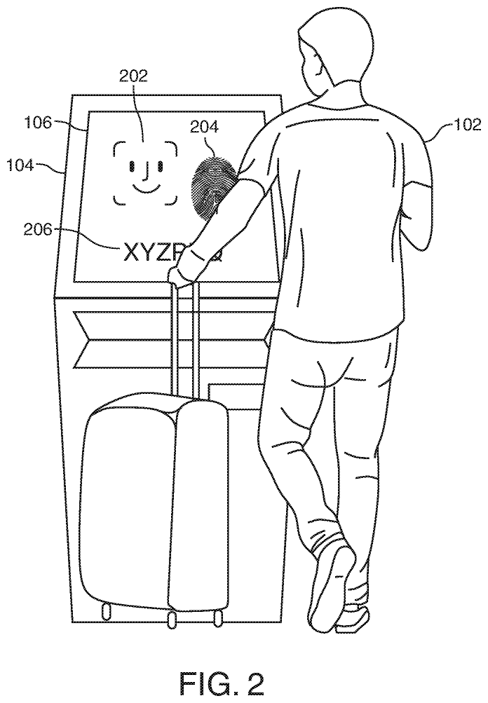

FIG. 2 shows an illustrative diagram. The illustrative diagram shows traveler 102 entering one or more biometric identifiers onto international kiosk 104. The biometric identifiers shown may include face scan 202 and fingerprint 204.

In addition to the biometric identifier, traveler 102 may enter a PIN, such the PIN shown at 206.

International traveler's kiosk 104 may generate a digital rendering of the biometric identifier.

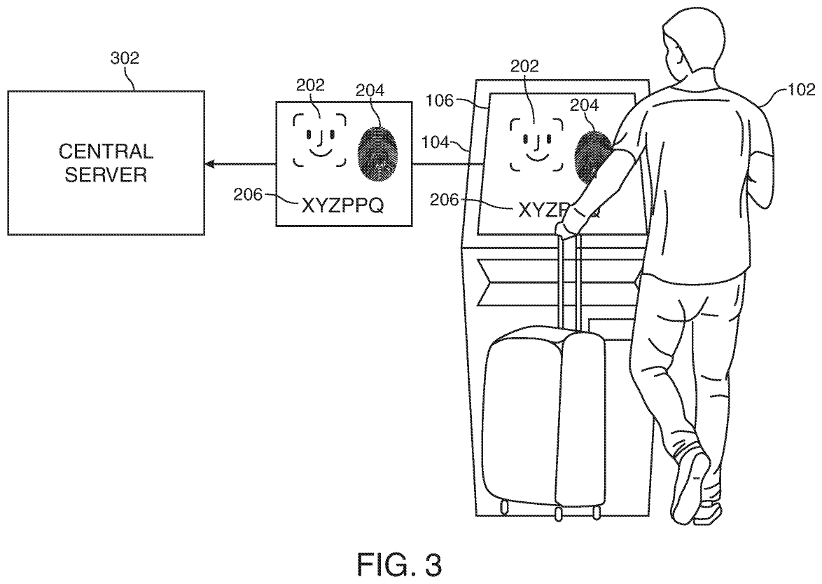

FIG. 3 shows another illustrative diagram. As shown in the illustrative diagram, international traveler's kiosk 104 may transmit the digital rendering of one or more biometric identifiers to central server 302. PIN 206 may also be transmitted from international traveler's kiosk 104 to central server 302.

The digital rendering and the PIN may be transmitted to the central server for authentication and verification. Upon receipt of the digital rendering and PIN at central server 302, central server 302 may initially validate and authenticate the traveler. For example, the central server may validate that the PIN is correct for the received digital rendering.

Upon authentication at the central server, the central server may locate personally identifiable information associated with the digital rendering. Such personally identifiable information may include name and address data, bank account data, itinerary data and any other suitable personally identifiable information. As such, the traveler may be able to access sensitive data without maintaining copies of the sensitive data while traveling.

In addition, the personally identifiable information may also include look and feel preferences of an automated teller machine associated with the traveler. Such look and feel preferences may include language preferences, color preferences, display preferences—e.g., screen arrangement—and other such preferences. The look and feel preferences may be imported into the international traveler's kiosk. The look and feel preferences may ease the traveler's transition while traveling.

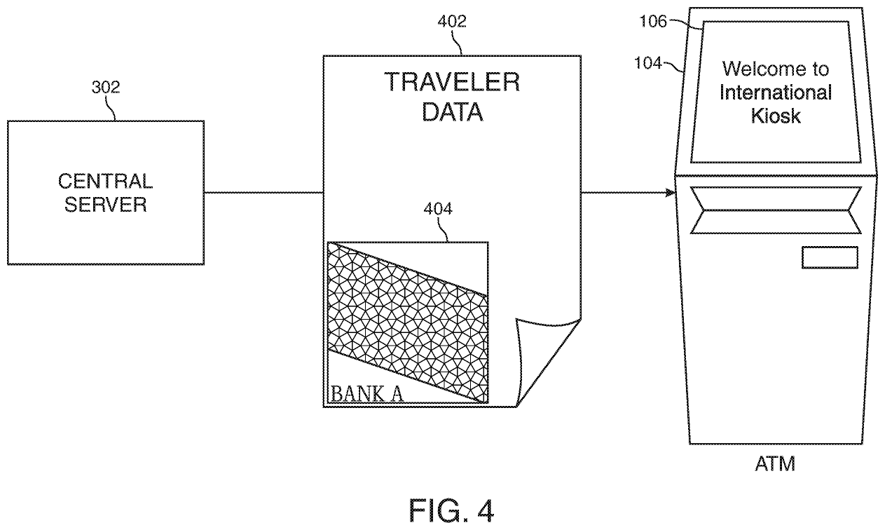

FIG. 4 shows another illustrative diagram. Central server 302 may transmit traveler data to international traveler's kiosk 104. The traveler data may include look and feel preferences, such as those shown at 404. Look and feel preferences 404 may include background graphics, display font size, location of various selectable items within the display and other suitable preferences.

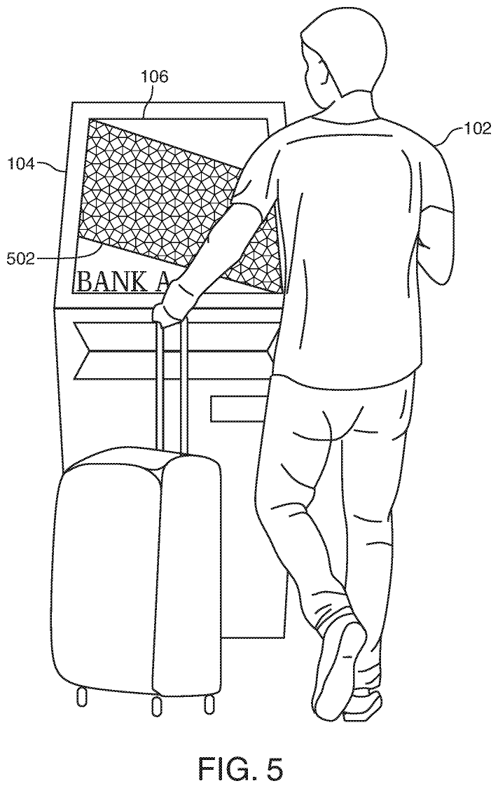

FIG. 5 shows an illustrative diagram. The illustrative diagram shows traveler 102 at international traveler's kiosk 104. Look and feel characteristics 502 may be imported onto display 106.

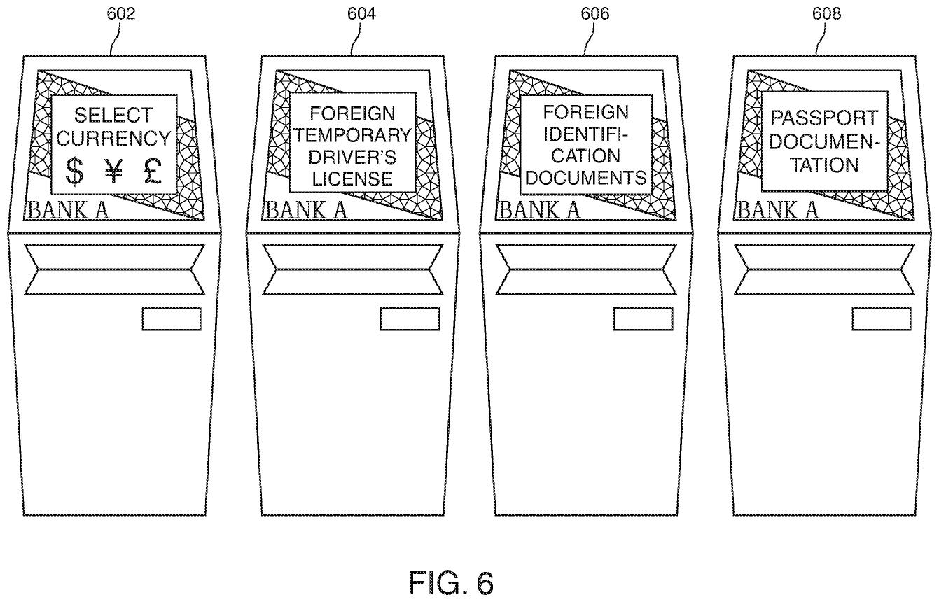

FIG. 6 shows an illustrative diagram. The illustrative diagram shows kiosks 602, 604, 606 and 608.

Kiosk 602 may include look and feel characteristics 502. Kiosk 602 may enable the option for a traveler to select and dispense currency.

Kiosk 604 may include look and feel characteristics 502. Kiosk 502 may enable the option for a traveler to print a foreign temporary driver's license.

Kiosk 606 may include look and feel characteristics 502. Kiosk 606 may enable the option for a traveler to print foreign identification documents.

Kiosk 608 may include look and feel characteristics 502. Kiosk may enable the option for a traveler to print passport documentation.

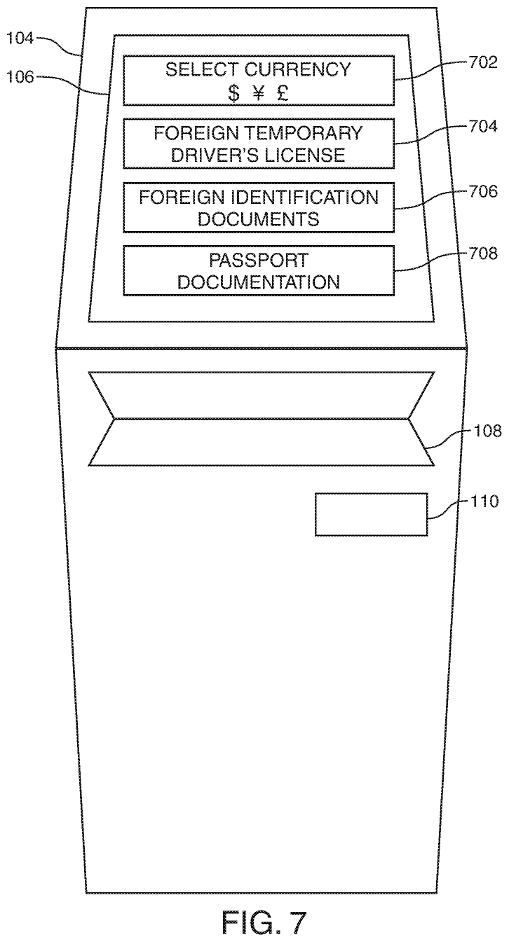

FIG. 7 shows an illustrative diagram. The illustrative diagram shows display 106 with multiple selectable options. The selectable options may include select currency, shown at 702. The selectable options may include foreign temporary driver's license, shown at 704. The selectable options may include foreign identification documents, shown at 706. The selectable options may include passport documentation, shown at 708.

Incoming/outgoing slots 108 and 110 may receive and dispense currency and/or documentation relating to selectable options 702, 704, 706 and 708.

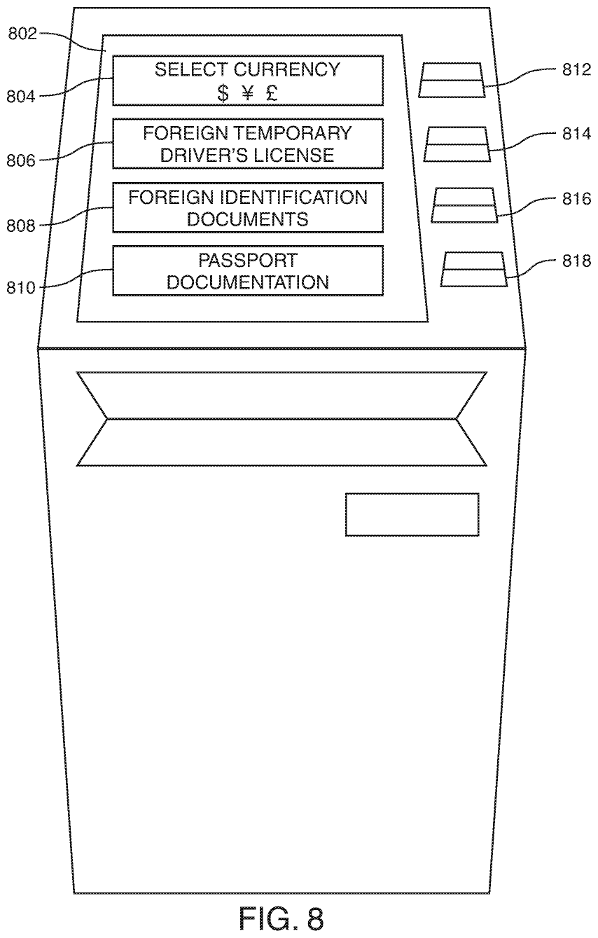

FIG. 8 shows an illustrative diagram. The illustrative diagram shows kiosk 802. Kiosk 802 may include multiple selectable displays. Each of the selectable displays may be associated with an incoming/outgoing slot.

Selectable display 804 may enable a traveler to select and dispense currency. Incoming/outgoing slot 812 may be associated with selectable display 804.

Selectable display 806 may enable a traveler to print a foreign temporary driver's license. Incoming/outgoing slot 814 may be associated with selectable display 806.

Selectable display 808 may enable a traveler to print foreign identification documents. Incoming/outgoing slot 816 may be associated with selectable display 808.

Selectable display 812 may enable a traveler to print passport documentation. Incoming/outgoing slot 818 may be associated with selectable display 818.

Thus, a biometric travel system is provided. Persons skilled in the art will appreciate that the present invention can be practiced by other than the described embodiments, which are presented for purposes of illustration rather than of limitation. The present invention is limited only by the claims that follow.

1. A kiosk for international travel, said kiosk comprising:
a biometric reader, said biometric reader operable to read a traveler's biometric identifier;
a processor operable to generate a digital rendering of the biometric identifier;
a transmitter, said transmitter operable to transmit the digital rendering of the biometric identifier to a central server;
a receiver, said receiver operable to receive, from the central server, personally identifiable information associated with the traveler, said personally identifiable information comprising a plurality of look and feel preferences associated with an automated teller machine associated with the traveler; and
a display, said display operable to display the plurality of look and feel preferences of the automated teller machine associated with the traveler.

2. The kiosk of claim 1 wherein the plurality of look and feel preferences comprise a plurality of selectable options.

3. The kiosk of claim 2 wherein the plurality of look and feel preferences comprise, for each of the plurality of selectable options, a location with respect to the display.

4. The kiosk of claim 1 wherein the plurality of look and feel preferences comprise one or more colors to be displayed on the display.

5-20. (canceled)
